(19) United States
(12) Patent Application Publication
(10) Pub. No.: US 2019/0078473 A1
(43) Pub. Date: Mar. 14, 2019

(54) ELECTRIC PHASER WITH ORBITING ECCENTRIC GEARS

(71) Applicant: BorgWarner Inc., Auburn Hills, MI (US)

(72) Inventors: Daniel BROWN, Freeville, NY (US); Alexander L. KAPELEVICH, Shoreview, MN (US)

(21) Appl. No.: 16/124,401

(22) Filed: Sep. 7, 2018

Related U.S. Application Data
(60) Provisional application No. 62/555,822, filed on Sep. 8, 2017.

(51) Int. Cl. F01L 1/348; F02D 13/02

(52) U.S. Cl. CPC F01L 1/348; F02D 13/0219; F01L 2800/06; F01L 2250/06; F01L 2250/04

(57) ABSTRACT

A variable camshaft timing device (10) that adjusts phase between a camshaft and a crankshaft including a camshaft ring gear (22) having a plurality of radially-inwardly facing gear teeth (24) each of which has an involute gear tooth profile; a sprocket ring gear (14) axially spaced from the camshaft ring gear (22) having a plurality of radially-inwardly facing gear teeth (18) each of which has an involute gear tooth profile; a compound planetary gear (26) having a camshaft planetary gear (74) and a sprocket planetary gear (72) that each face radially outwardly and include a plurality of radially-outwardly facing gear teeth (76, 78) having involute gear tooth profiles; and an eccentric shaft (28) that communicates rotational force from an electric motor (30) to the compound planetary gear (26) relatively displacing the camshaft ring gear (22) with respect to the sprocket ring gear (14).

### CROSS-REFERENCE TO RELATED APPLICATIONS

This application claims the benefit of U.S. Patent Application No. 62/555822 filed on Sep. 8, 2017, the disclosure of which is herein incorporated by reference in its entirety

### TECHNICAL FIELD

The present application relates to variable camshaft timing (VCT) in an internal combustion engine and, more particularly, to electrically-controlled camshaft phasers that use involute gears.

### BACKGROUND

Internal combustion engines include camshafts that open and close valves regulating the combustion of fuel and air within combustion chambers of the engines. The opening and closing of the valves are carefully timed relative to a variety of events, such as the injection and combustion of fuel into the combustion chamber and the location of the piston relative to top-dead center (TDC). Camshaft(s) are driven by the rotation of the crankshaft via a drive member connecting these elements, such as a belt or chain. In the past, a fixed relationship existed between the rotation of the crankshaft and the rotation of the camshaft. Increasingly, internal combustion engines now use camshaft phasers that vary the phase of camshaft rotation relative to crankshaft rotation.

A variety of different camshaft phaser designs exist. Some camshaft phasers rely on hydraulic fluid to adjust the angular position of the camshaft relative to the crankshaft while others are actuated by electric motors that advance or retard the opening/closing of valves relative to crankshaft rotation. Camshaft phasers that are actuated by electric motors can use a plurality of gears to vary the angular position of a camshaft relative to a crankshaft. For example, these types of camshaft phaser have been implemented using a harmonic drive or planetary gears having cycloidal gear teeth that change the angular position between the camshaft and the crankshaft. The cycloidal tooth design of these gears can affect the performance of the electrically-actuated camshaft phaser.

The gear tooth design used by the plurality of gears can make implementation of the phaser more challenging. For example, electrically controlled camshaft phasers use gears that have cycloidal gear teeth. But manufacturing cycloidal gear teeth involves very precise tolerances. And changes in distance between an operating center of the camshaft phaser gear and a nominal center of that gear can cause tooth tip interference. Therefore, the design of the gear teeth used by gears in electrically actuated or controlled camshaft phasers can be improved.

### SUMMARY

A variable camshaft timing device that adjusts phase between a camshaft and a crankshaft, includes a first ring gear, configured to connect to the camshaft and rotate about a center axis (x), having a plurality of radially-inwardly facing gear teeth each of which has an involute gear tooth profile; a second ring gear axially spaced from the first ring gear, configured to receive rotational input from the crankshaft and rotate about the center axis (x), having a plurality of radially-inwardly facing gear teeth each of which has an involute gear tooth profile; a compound planetary gear having a camshaft planetary gear and a sprocket planetary gear that each face radially outwardly and include a plurality of radially-outwardly facing gear teeth having involute gear tooth profiles, wherein the camshaft planetary gear contacts the first ring gear and the sprocket planetary gear contacts the second ring gear; and an eccentric shaft that communicates rotational force from an electric motor to the compound planetary gear relatively displacing the first ring gear with respect to the second ring gear.

### BRIEF DESCRIPTION OF THE DRAWINGS

FIG. 1 is an exploded view of an embodiment of an electrically-actuated camshaft phaser having gear teeth with an involute gear tooth profile;

FIG. 2 is another exploded view of an embodiment of an electrically-actuated camshaft phaser having gear teeth with an involute gear tooth profile;

FIG. 3 is a cross-sectional view of an embodiment of an electrically-actuated camshaft phaser having gear teeth with an involute gear tooth profile;

FIG. 4 is a profile view of an embodiment of a portion electrically-actuated camshaft phaser having gear teeth with an involute gear tooth profile;

FIG. 5 is a profile view of an embodiment of gear teeth having involute gear profiles; and

FIG. 6 is a cross-sectional view of an embodiment of a compound planetary gear used by an electrically-actuated camshaft phaser.

### DETAILED DESCRIPTION

An electrically-actuated camshaft phaser includes an eccentric shaft rotating a compound planet gear in contact with a sprocket ring gear and a camshaft ring gear. The compound planet gear, the sprocket ring gear, and the camshaft ring gear each include gear teeth that have an involute gear tooth profile or shape. The involute gear tooth profile used by the camshaft phaser gears can reduce noise, vibration, and harshness by allowing the operating center of the camshaft phaser gears to deviate from their nominal center without violating the fundamental law of gearing. The involute gear teeth have a pressure angle that is relatively high to avoid tooth tip interference. And in addition, the difference between the number of involute gear teeth included on the ring gears and the involute gear teeth on the compound planet gear can vary by more than one tooth. In the past, the electrically-actuated camshaft phasers have been implemented using an eccentric shaft rotating a planet gear having cycloidal gear teeth that changes the angular position between the camshaft and the crankshaft. The cycloidal tooth design of these gears can be challenging to implement and affect the performance of the electrically-actuated camshaft phaser when not precisely machined.

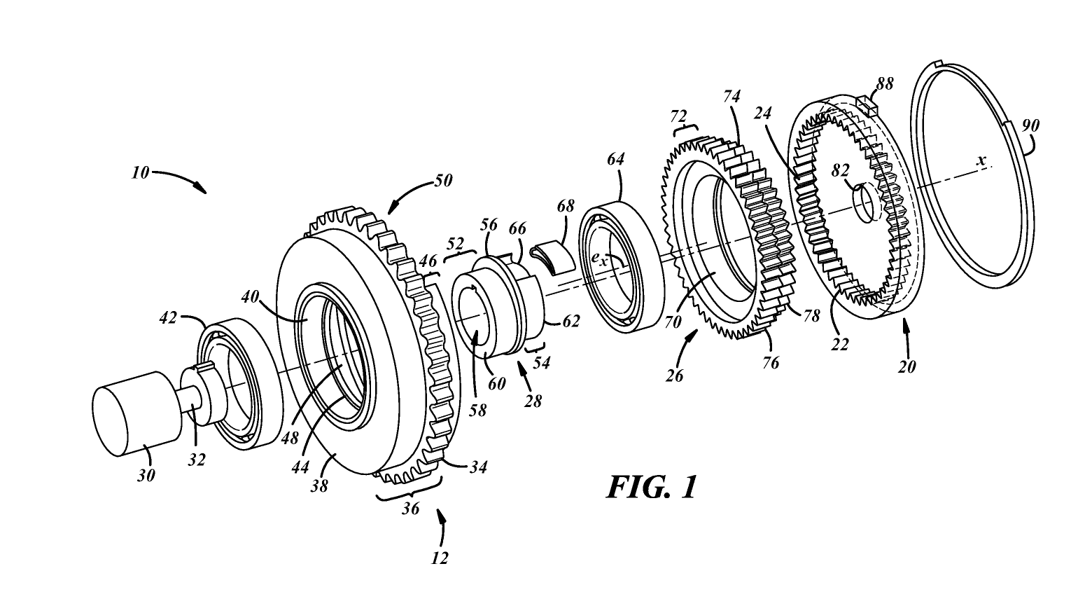

An embodiment of an electrically-controlled camshaft phaser that is controlled using an electric motor and an eccentric shaft is shown in FIG. 1. The camshaft phaser 10 includes a crankshaft sprocket 12 that connects to a crankshaft and includes a sprocket ring gear 14 and a sprocket bearing 16. The sprocket ring gear 14 includes a set of inwardly-facing gear teeth 18 each of which have an involute gear profile. A camshaft plate 20 attaches to a camshaft and includes a camshaft ring gear 22 comprising a separate set of inwardly-facing gear teeth 24. Each of the gear teeth 24 of the camshaft ring gear 22 also have an involute gear profile. A compound planetary gear 26 uses two sets of outwardly facing gear teeth that each engage with the camshaft ring gear 22 and the sprocket ring gear 14. The outwardly-facing gear teeth each have an involute gear profile. An eccentric shaft 28 connects to the crankshaft sprocket 12 or the camshaft plate 20 such that a portion of the eccentric shaft 28 rotates about the axis (x). The eccentric shaft 28 also connects to the compound planetary gear 26 along an eccentric axis (ex). The crankshaft sprocket 12 and the camshaft plate 20 each rotate about axis (x). A portion of the eccentric shaft 28 is rotationally driven by an electric motor 30 about axis x according to desired phasing such that the compound planetary gear 26 rotates about the eccentric axis ex.

Operating the electric motor 30 so that an output shaft 32 rotates the eccentric shaft 28 at the same speed as the crankshaft sprocket 12 maintains an existing angular position of the camshaft relative to the crankshaft. Changing the rate at which the output shaft 32 rotates relative to the rate at which the crankshaft sprocket 12 rotates changes the angular position (also called “phase”) of the camshaft relative to the crankshaft. For example, when the output shaft 32 rotates faster than the crankshaft sprocket 12, the eccentric shaft 28 rotates the compound planetary gear 26 relative to the sprocket ring gear 14 and the camshaft ring gear 22 thereby displacing the camshaft plate 20 relative to the crankshaft sprocket 12 to advance the phase of the camshaft relative to the crankshaft. And when the output shaft 32 rotates slower than the crankshaft, the eccentric shaft 28 rotates the compound planetary gear 26 relative to the sprocket ring gear 14 and the camshaft ring gear 22 thereby displacing the camshaft plate 20 relative to the camshaft sprocket 12 to retard the phase of the camshaft relative to the crankshaft.

The crankshaft sprocket 12 receives rotational drive input from the engine's crankshaft and rotates about the axis x. An endless loop power transmission member, such as a timing chain or a timing belt, can be looped around the sprocket 12 and around the crankshaft so that rotation of the crankshaft translates into rotation of the sprocket 12 via the member. Other techniques for transferring rotation between the sprocket 12 and crankshaft are possible. Along an outer surface, the sprocket 12 has a plurality of sprocket teeth 34 for mating with the timing chain, with the timing belt, or with another component. As shown, the sprocket 12 has a housing 36 spanning axially from the sprocket teeth 34. The housing 36 includes the sprocket ring gear 14 within the housing 36 spaced axially and radially inward from the teeth 34. The sprocket ring gear 14 includes a plurality of inwardly-facing gear teeth 18 and an end plate 38 at least partially closing one end of the sprocket 12. The end plate 38 includes a bearing opening 40 that is roughly the same diameter as the sprocket bearing 16. The sprocket bearing 16 is received by the sprocket 12 in the bearing opening 40 and abuts a bearing shoulder 44. The gear teeth 18 of the sprocket ring gear 14 can be offset axially from the sprocket teeth 34 and the sprocket bearing 16.

The housing 36 also includes an end-stop section 46 that is annularly shaped and extends axially from the sprocket teeth 34 toward the camshaft. The end-stop section 46 includes a relatively smooth inwardly-facing surface 48 as well as a stop guide 50 that controls the range of authority of the camshaft phaser 10. The stop guide 50 comprises an angular section of the end-stop section 46 that has a reduced axial length relative to other portions of the section 46. An end stop carried by the camshaft plate 20 can be constrained within a range of angular motion relative to the crankshaft sprocket 12 by the stop guide 50. This will be discussed below in greater detail.

The eccentric shaft 28 includes a crankshaft portion 52 and a planet portion 54 one of which is eccentric to the other. The crankshaft portion 52 and planet portion 54 can be eccentric to each other by more than 2.0 millimeters (mm). In one implementation, the crankshaft portion 52 is eccentric from the planet portion 54 by 2.5 mm and in another implementation the crankshaft portion 52 is eccentric from the portion 54 by 2.9 mm. However, other eccentricity amounts could be used. The eccentricity amount can be varied such that it is large enough so that manufacture within tolerances is consistently achieved yet small enough to still allow the center bolt to pass through an axial bore 58 in the eccentric shaft 28 and attach the camshaft plate 20 to the camshaft. The crankshaft portion 52 and the planet portion 54 can be separated by a shoulder 56 that radially extends from the eccentric shaft 28. The axial bore 58 can extend from a sprocket side 60 of the eccentric shaft 28 to a camshaft side 62 of the eccentric shaft 28. The axial bore 58 on the sprocket side 60 of the eccentric shaft 28 can be configured to receive an end of the output shaft 32. The output shaft can use a keyed end that fits with a corresponding keyed recess in the axial bore 58. The crankshaft portion 52 can be substantially annular having an outside surface that closely conforms to an inner diameter of the sprocket bearing 16. The planet portion 54 is axially spaced and eccentric relative to the crankshaft portion 52. An outer surface of the planet portion 54 closely conforms to an inner diameter of a planet bearing 64 and includes a recess 66 for receiving a planetary biasing member 68. The planetary biasing member 68 can help forcibly engage the compound planetary gear 26 with the sprocket ring gear 14 and the camshaft ring gear 22. One end of the planetary biasing member 68 can engage the eccentric shaft 28 at the recess 66 and another end of the member 68 can direct force radially outwardly and toward an internal surface 70 of the compound planetary gear 26. The recess 66 is located on the outer surface of the camshaft portion and includes a reduced diameter section that can prevent movement of the planetary biasing member 68.

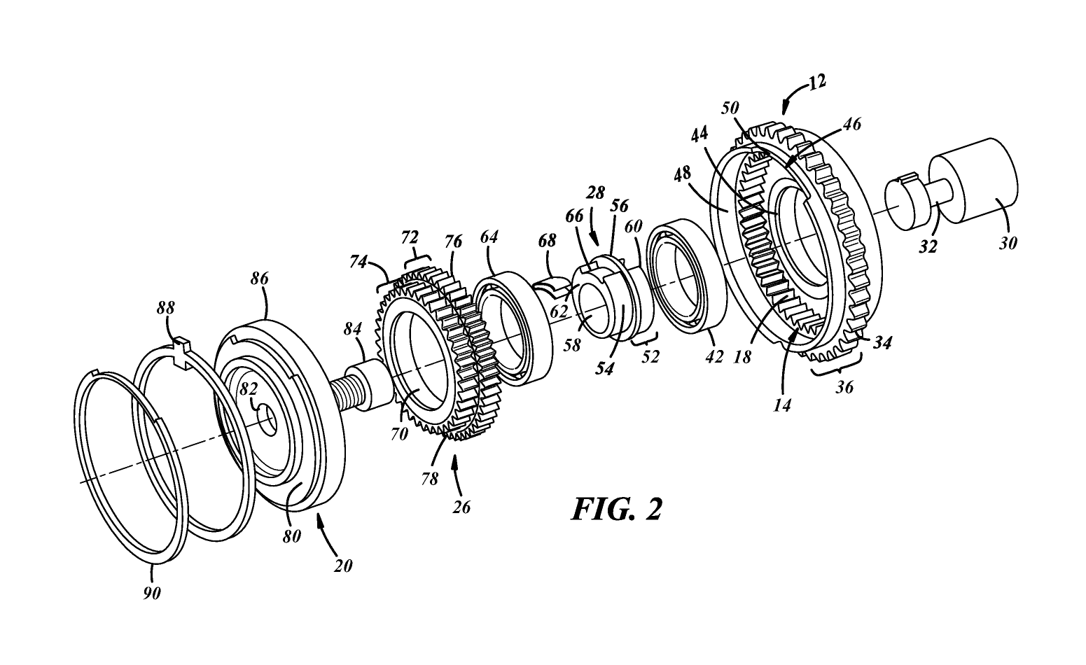

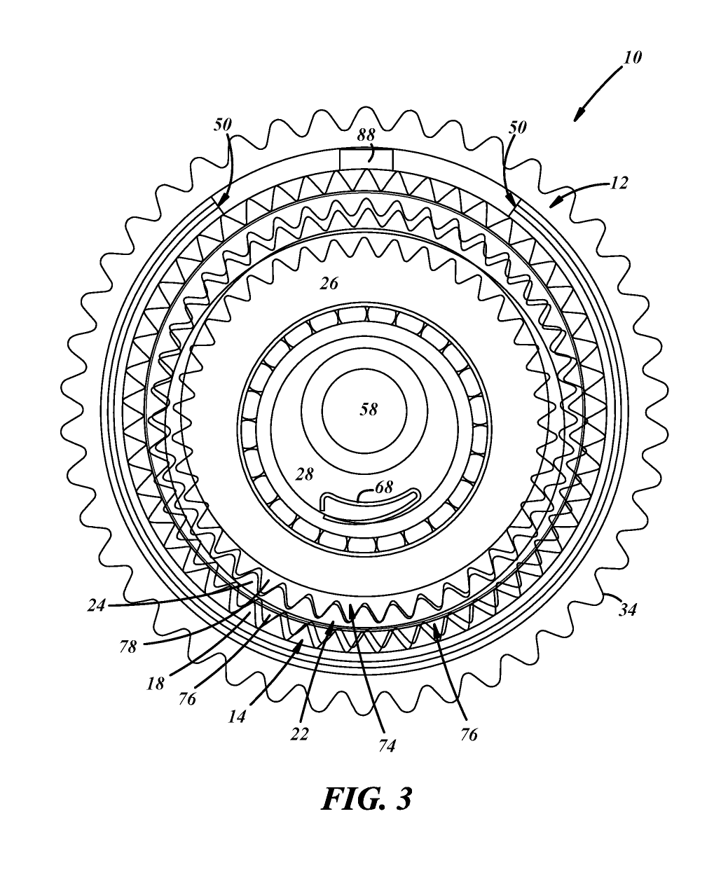

The sprocket bearing 16 and the planet bearing 64 can be implemented in a variety of ways. For example, the bearings could be single-row, deep-groove bearings, double-row bearings, a combination of a single-row bearing and a deep-groove bearing, X-contact or gothic arch bearings, or needle bearings, to identify some possible implementations. And while the implementation shown with respect to FIGS. 1-3 depicts a sprocket bearing 16 and a planet bearing 64, other implementations of eccentric camshaft phasers can use a bearing that connects the eccentric shaft with the camshaft plate rather than the sprocket.

The compound planetary gear 26 includes a sprocket planetary gear 72 and a camshaft planetary gear 74. The sprocket planetary gear 72 and the camshaft planetary gear 74 include a set of outwardly-facing sprocket planetary gear teeth 76 that engage with the sprocket ring gear 14 and a set of outwardly-facing camshaft planetary gear teeth 78 that engage with the camshaft ring gear 22, respectively. The gear teeth 18 of the sprocket ring gear 14 and the gear teeth 24 of the camshaft ring gear 22 as well as the gear teeth 76, 78 of the compound planetary gear 26 each have an involute gear profile. The profiles of involute gear teeth are involutes of a circle such that contact between two gear teeth occurs at a point along a line of action that moves as the gears rotate. Also, the number of gear teeth 76 used by the sprocket planetary gear 72 is different than the number of gear teeth 18 used by the sprocket 12 by more than one. That is, the camshaft planetary gear 74 includes two or more additional gear teeth 78 relative to number of gear teeth 76 on the sprocket planetary gear 72. In one embodiment, the camshaft planetary gear 74 includes four additional gear teeth 78 relative to the sprocket planetary gear 72. The number of gear teeth 78 used by the camshaft planetary gear 74 is different than the number of gear teeth 18 used by the sprocket 12 by more than one and, in one embodiment, can be different by a value of four. The involute gear profile of these teeth and others will be discussed in greater detail below.

The camshaft plate 20 is configured to be attached to the camshaft and includes the camshaft ring gear 22. A camshaft plate end 80 substantially closes one end of the camshaft plate 20 and includes a bolt aperture 82 through which a retention bolt 84 passes and couples the camshaft to the camshaft plate 20. While in this embodiment a single retention bolt 84 is shown, other implementations could use a plurality of retention bolts. The plurality of retention bolts can permit the use of greater offset between a crankshaft portion 52 of the eccentric shaft 28 and the planet gear portion 54. In addition, the camshaft plate 20 includes an outer surface 86 that abuts the inwardly-facing surface 48 of the sprocket 12 so that the outer surface 86 of the camshaft plate 20 is radially-inward from the inwardly-facing surface 48 of the sprocket 12. An end stop 88 can attach to and extend radially outwardly from the outer surface 86 of the camshaft plate 20. When the camshaft phaser 10 is assembled and the outer surface 86 of the camshaft plate 20 abuts surface 48, the end stop 88 is confined within the stop guide 50 such that relative rotation between the sprocket 12 and the camshaft plate 20 is constrained. As the camshaft plate 20 rotates relative to the sprocket 12, the end stop 88 moves within the stop guide 50. The camshaft planetary gear 74 can have a diameter that is smaller than the sprocket planetary gear 72. And the different diameters of the camshaft planetary gear 74 and the sprocket planetary gear 72 can correspond to different diameters of the camshaft ring gear 22 and sprocket ring gear 14.

When the camshaft phaser 10 is assembled, the sprocket 12 receives the sprocket bearing 16 and the sprocket side 60 of the eccentric shaft 28 is inserted within the inner diameter of the sprocket bearing 16. The planetary biasing member 68 can be inserted into and compressed toward the recess 66 while the inside diameter of the planet bearing 64 is fit over the planet gear portion 54. The compound planetary gear 26 is attached to the planet bearing 64 by placing the internal surface 70 over the outer diameter of the planet bearing 64. The camshaft plate 20 is fit in close proximity to the compound planetary gear 26 so that the gear teeth 24 of the camshaft ring gear 22 contact the camshaft planetary gear teeth 78 and are located radially outwardly from the teeth 78. The sprocket bearing 16, the eccentric shaft 28, the planet bearing 64, the compound planetary gear 26, and the camshaft plate 20 are located within the sprocket housing 36. A cam ring 90 can be forcibly fit into a radial groove in the sprocket 12 to axially constrain the elements of the camshaft phaser within the sprocket housing 36.

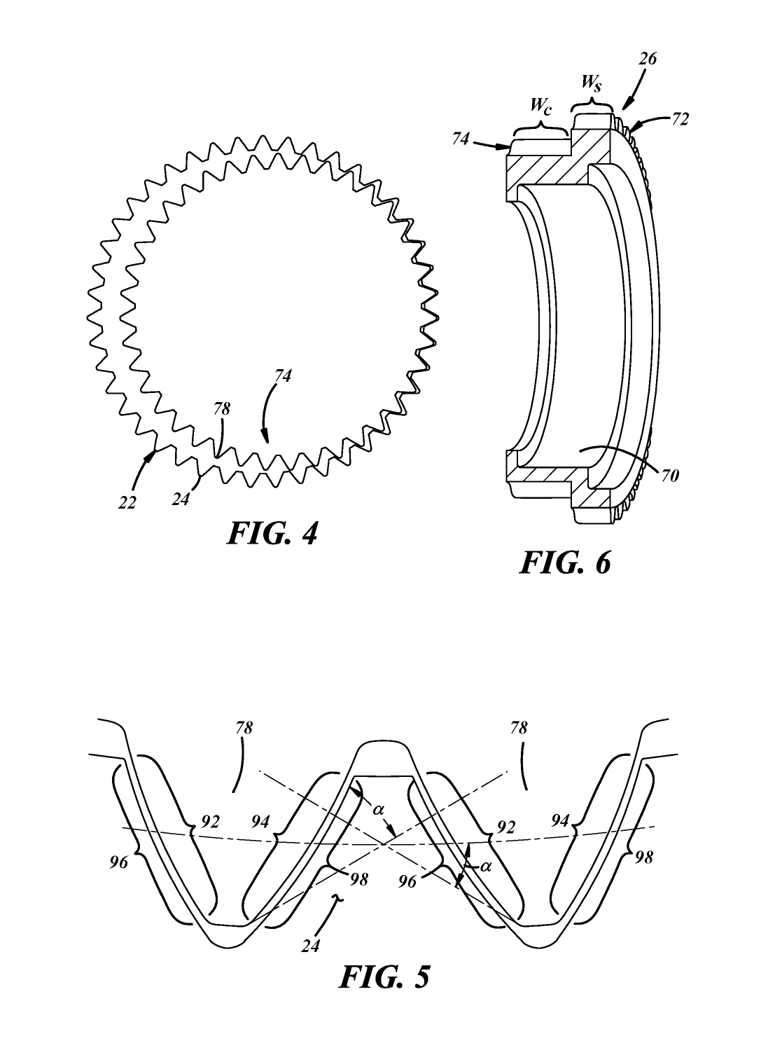

Turning to FIGS. 4-5, depict the involute gear profiles of the gear teeth 78 of the camshaft planetary gear 74 as they engage the gear teeth 24 of the camshaft ring gear 22. Each of the gear teeth include two faces. For example, the gear teeth 78 each have a first camshaft planetary gear face 92 and a second camshaft planetary gear face 94. And the gear teeth 24 each include a first camshaft ring gear face 96 and a second camshaft ring gear face 98. As the gear teeth 24 of the camshaft ring gear 22 mesh with the gear teeth 78 of the camshaft planetary gear 74, the first camshaft planetary gear face 92 contacts the first camshaft ring gear face 96 or the second camshaft planetary gear face 94 contacts the second camshaft ring gear face 98, depending on the direction in which the camshaft planetary gear 74 rotates. The first camshaft planetary gear face 92, the second camshaft planetary gear face 94, the first camshaft ring gear face 96, and the second camshaft ring gear face 98 each have involute gear profiles such that they are involutes of a circle.

In one embodiment, the pressure angle (a) for the first camshaft planetary gear face 92 and the second camshaft planetary gear face 94 is thirty degrees. However, other pressure angles can be used. Generally speaking, pressure angles greater than twenty-five degrees can be used. These pressure angles are non-standard, yet pressure angle values higher than twenty-five degrees help avoid gear tooth tip interference between planet and ring gears. The pressure angles can be varied in proportion to the module of the gears. The larger the module, the lower the pressure angles that can be used. In the embodiment shown, the pressure angle of the first camshaft planetary gear face 92 and the second camshaft planetary gear face 94 is the same. However, it is possible to have one pressure angle on a driven tooth face and another, different pressure angle on a driving tooth face. In this way, the gears can be made stronger for transmitting load in one direction than if the pressure angle were the same on both gear faces. The gears may be designed to account for the direction of mean load or for the direction with higher peak loads. For example, the pressure angle for the first camshaft planetary gear face 92 may be 27 degrees and the second camshaft planetary gear face 94 may be 33 degrees. As a result, the gear teeth can be asymmetrical.

Turning to FIG. 6, another embodiment of the compound planetary gear 26 used with the camshaft phaser 10 is shown. The sprocket planetary gear 72 and the camshaft planetary gear 74 in this implementation have different gear widths. As can be appreciated from FIG. 6, the gear width of the sprocket planetary gear 72 (Ws) is narrower or shorter than the gear width of the camshaft planetary gear 74 (Wc). These widths can be defined based on an increased amount of load on one gear relative to another. The gear bearing the increased load can have a wider gear width relative to the other gear. And the relative relationship between gear widths can depend on the relative loads born by each gear. The gear width bearing the increased load can be longer that the gear face with less load.

It is to be understood that the foregoing is a description of one or more embodiments of the invention. The invention is not limited to the particular embodiment(s) disclosed herein, but rather is defined solely by the claims below. Furthermore, the statements contained in the foregoing description relate to particular embodiments and are not to be construed as limitations on the scope of the invention or on the definition of terms used in the claims, except where a term or phrase is expressly defined above. Various other embodiments and various changes and modifications to the disclosed embodiment(s) will become apparent to those skilled in the art. All such other embodiments, changes, and modifications are intended to come within the scope of the appended claims

As used in this specification and claims, the terms “e.g.,” “for example,” “for instance,” “such as,” and “like,” and the verbs “comprising,” “having,” “including,” and their other verb forms, when used in conjunction with a listing of one or more components or other items, are each to be construed as open-ended, meaning that the listing is not to be considered as excluding other, additional components or items. Other terms are to be construed using their broadest reasonable meaning unless they are used in a context that requires a different interpretation.

What is claimed is:

1. A variable camshaft timing device (10) that adjusts phase between a camshaft and a crankshaft, comprising:
a camshaft ring gear (22), configured to connect to the camshaft and rotate about a center axis (x), having a plurality of radially-inwardly facing gear teeth (24) each of which has an involute gear tooth profile;
a sprocket ring gear (14) axially spaced from the camshaft ring gear (22), configured to receive rotational input from the crankshaft and rotate about the center axis (x), having a plurality of radially-inwardly facing gear teeth (18) each of which has an involute gear tooth profile;
a compound planetary gear (26) having a camshaft planetary gear (74) and a sprocket planetary gear (72) that each face radially outwardly and include a plurality of radially-outwardly facing gear teeth (76, 78) having involute gear tooth profiles, wherein the camshaft planetary gear (74) contacts the camshaft ring gear (22) and the sprocket planetary gear (72) contacts the sprocket ring gear (14); and
an eccentric shaft (28) that communicates rotational force from an electric motor (30) to the compound planetary gear (26) relatively displacing the camshaft ring gear (22) with respect to the sprocket ring gear (14).

2. The variable camshaft timing device (10) of claim 1, wherein a quantity of gear teeth (24) included on the camshaft ring gear (22) and a quantity of gear teeth (78) included on the camshaft planetary gear (74) differs by more than one.

3. The variable camshaft timing device (10) of claim 1, wherein a quantity of gear teeth (18) included on the sprocket ring gear (14) and a quantity of gear teeth (76) included on the sprocket planetary gear (72) portion differs by more than one.

4. The variable camshaft timing device (10) of claim 1, wherein the involute gear tooth profile is greater than twenty-one degrees.

5. The variable camshaft timing device (10) of claim 1, wherein the involute gear tooth profile equals thirty degrees.

6. The variable camshaft timing device (10) of claim 1, wherein a pressure angle between a first camshaft planetary gear face (92) and a first camshaft ring gear face (96) is different from a pressure angle between a second camshaft planetary gear face (94) and a second camshaft ring gear face (98).

7. The variable camshaft timing device (10) of claim 1, wherein a length of a first camshaft planet gear face (92) is different than a length of a second camshaft planet gear face (94).

8. The variable camshaft timing device (10) of claim 1, wherein a length of a first camshaft ring gear face (96) is different than a length of a second camshaft ring gear face (98).

9. The variable camshaft timing device (10) of claim 1, wherein a crankshaft portion (52) of the eccentric shaft (28) is eccentric from a planet portion (54) more than 2.0 millimeters.

10. The variable camshaft timing device (10), further comprising a biasing member (68) that engages the eccentric shaft (28) and forces the compound planet gear (26) into contact with the camshaft ring gear (22) and the sprocket ring gear (14).
